(19) United States
(12) Patent Application Publication
(10) Pub. No.: US 2006/0154216 A1
(43) Pub. Date: Jul. 13, 2006

(54) Touch-sensitive interface

(76) Inventors: Moustapha Hafez, Paris (FR); Jean-Marc Alexandre, Amtony (FR)

Correspondence Address: Robert E. Krebs;Thelen Reid & Preist, P.O. Box 640640, San Jose, CA, 95164-0640, US

(21) Appl. No.: 10/540,118

(22) PCT Filed: Dec. 17, 2003
(86) PCT No.: PCT/FR03/50187

§ 371 Date: Feb. 10, 2006

(30) Foreign Application Priority Data
Dec. 19, 2002 (FR) 02/16177
Apr. 9, 2003 (FR) 03/50092

(51) Int. Cl. G09B 21/00

(52) U.S. Cl. 434/113

(57) ABSTRACT

A device (1) comprising a tactile interface in the form of a plate (10) comprising an array of elements (25) enabling a surface (10a) of the plate (10) to be modified in a controlled manner, characterised in that the plate (10) is made of a shape memory material, and in that each element (25) is made up of an array of blades (23) solid with the plate (10) by an arm (13) solid monolithically with the plate (10) and the blade, a recess (14) of freedom of blade being present around the blade (23), the blade (23) having a first position at a first temperature and a second position at a second temperature.

### TECHNICAL FIELD

The invention applies to the field of devices for transmitting tactile information to a user. It relates more particularly to a device comprising a tactile interface formed by a plate having a surface to be modified in a controlled manner, the plate comprising an array of elements for modification of the surface.

Such plates are especially employed in touch plates or tactile interfaces for communicating information for example in the field of cars or in communicating objects, for example portable telephones or computer mice or in the field of objects for blind people.

The invention applies also to the field of virtual reality, for example for reproducing the sensation of a texture.

### PRIOR ART

U.S. Pat. No. 6,159,013 describes a portable optic sensor for blind people. The device comprises a touch plate fitted with holes in which surface element modification of the plate constituted in this case by rods are mobile. The position of the rods is controlled electromagnetically.

An address circuit associated with address control means receiving the tactile data to be displayed determines the circulation of currents in control coils of the position of the rods.

According to its position, a rod emerges or does not emerge from a touch surface of the touch plate. The control of each of the rods allows forming of patterns on the plate.

There are also tactile interfaces based on thermal actuators, especially shape memory alloys (SMA) utilising only wires as actuators. The movement of the part actuated by the wire is slight. Various solutions have been put forward for amplifying the movement of the mobile part, especially by using lever arms and return springs. However, as soon as it is preferred to increase the resolution of the touch plate, that is, increase the number of modification elements per surface unit of the plate, the assembly of plate and elements becomes very complicated and the system becomes bulky.

The shape memory alloys (SMA) are known per se. These are alloys capable of transforming thermal energy provided to them during mechanical work. They can thus give back deformations of the order of 6 to 8% and generate relatively significant efforts when they are heated. In addition, the SMA are in general low in cost and the physical implementation of the heating operation can be carried out simply. When a piece made of SMA passes from a first to a second temperature, its mechanical form changes and passes from a first to a second form. Two-way effects can also be obtained. For this purpose the material is given a first shape. It is heated in this first shape, then cooled; it retains its first shape. It is then subjected to thermal cycle processing in a second shape. After this thermal cycle processing the material has, in the hot state, the first shape and, in the cold state, the second shape.

### SHORT DESCRIPTION OF THE INVENTION

The aim of the present invention is a device comprising a tactile interface formed by a plate. The plate has a surface capable of being modified in a controlled manner. For this purpose the plate comprises an ensemble of mobile parts of the modification element of the surface which is simple to produce and compact. The aim of the present invention is likewise a device comprising a tactile interface having large modification resolution. When it comes to plate, this does not necessarily signify only the plate with a flat shape. It can be for example a cylindrical surface in the geometric sense. It can also be one or more layers deposited on a substrate by technologies used in microelectronics.

According to the present invention these aims are reached by the fact that in the device comprising the tactile interface the plate is made of a shape memory material, or comprises at least one sub-plate made of such a material. Also, the array of mobile parts of modification elements of the plate is made up of an array of one or more blade(s) solid monolithically with the plate by one or more arms solid monolithically with the blade and the plate, one or more recesses to release blade(s) being present on a part of a perimeter of the blade, the blade having a first position at a first temperature and a second position at a second temperature. The device comprises control means of the surface element modification.

To pass from the first to the second form, it suffices to apply local heating to the blade or preferably to a linking arm of the blade on the rear of the plate. To return from the second to the first position of the blade, it suffices to let it cool. It can also be cooled actively, for example by means of a Pelletier cell.

According to a first advantageous embodiment in which the plate is made of a shape memory material, the return to the first form is achieved by the fact that the plate has undergone thermal processing allowing two-way effect. In this case a first heating of a part from the plate causes a change in shape of this part from a first form to a second form. Cooling of this same part causes a return to the first form. This first embodiment allows control of the rest time of a pattern made on the plate.

According to a second embodiment in which the plate is made of a shape memory material, the blade is attached to the plate by several arms. One (or several) first arm(s) has (have) a memorised form, which it recovers by heating, and one (or more) second arms have not undergone local thermal processing. The return of the blade to the first form is assured or accelerated by the fact that the second arms exert an elastic return force on the first arms for returning the blade to its initial position.

According to a variant of this second embodiment where the return to the first form is effected by elastic means, the plate is formed with two sub-plates assembled for example by welding or bonding so as to form only a single plate. A first sub-plate is made of a shape memory material A. A second sub-plate is made of an elastic material B. A heated part of the first sub-plate made of material A will cause deformation of this part by deformation of the material causing elastic deformation of the material B. When, due to the fact of natural or active cooling of the material A, the material A is less rigid, the return of the material B to its initial form by elastic effect causes return to the first form of the materials A and B.

According to a third embodiment, in which the plate is made of shape memory material A, the plate is made up of two sub-plates made of shape memory material, a material A and a material C, identical or different to one another, for example in the form of two sub-plates welded or bonded to one another to form one single plate. Parts of the sub-plate made of material A have a first form in the cold state and a second form in the hot state. Corresponding parts of the sub-plate made of material C have a first form in the cold state and a second form when hot. The second form in the hot state of the corresponding part made of material C is such that in this form the sub-plate resumes its first form. This works as follows:

A part of the sub-plate made of material A for example, is deformed by heating and resumes its memorised form. The deformation of the part made of material A causes mechanical deformation of the corresponding part of the sub-plate made of material C. If at this stage the alloy C is heated, the alloy C resumes its memorised form such that the ensemble of the two alloys resumes the initial form.

In this third embodiment the two layers of material A and C are preferably attached to one another by means of a thermal insulating layer. The layers of material A and C can thus be heated independently. This third embodiment allows, as does the second form, control of the rest time of a pattern made on the plate.

In an embodiment the control means of the transformation means of the modification elements of the tactile sensation comprise one or more laser emitters whereof the radiation from each is utilised to effect transformation of one or more transformation means of modification elements of the tactile sensation.

The control means further comprise, as in the prior art, a control circuit for selecting, as a function of tactile data to be displayed at any given instant, the modification elements of the tactile sensation on which it is necessary to act to obtain display of the tactile data, and direct the radiation from the laser emitter to these selected elements. In the prior art these control means comprise an address circuit, and a control circuit of the address circuit which directly controls the address circuit addressing the elements which must be acted on.

This same configuration of the control means can be found in the invention for cases where there are as many laser emitters as transformation elements, each transformation element being in bijective correspondence with a laser emitter.

In general, there are one or more laser emitters, at least one of the laser emitters acting on several transformation elements. When there is a single laser emitter for all the transformation elements, the control means acting on shift means of the radiation output by this laser emitter to successively apply the radiation to the transformation elements which must be acted on, considering the tactile data to be displayed. When there are several laser emitters whereof some act on several transformation elements, the control circuit is in two stages, a first selection stage of the lasers whereof the radiation will be used to create the display, for example in the form of an address circuit controlling the emission of radiation of the laser emitters, these laser emitters being in correspondence, by way of distribution means of the radiation, with transformation means necessary for the formation of the projected display of the tactile data, and a second stage acting on shift means for shifting the radiation emitted by each laser whereof the radiation is utilised for the projected display, for successively applying the radiation to the transformation elements in correspondence with this laser emitter, which is to be acted on considering the tactile data to be displayed.

This aspect of the control means, relative to selection of the radiation useful for a given display and of the control of shifts of the radiation, is within the knowledge of the specialist and will not be taken up further in the present description.

There can be as many lasers as modification elements of the tactile sensation provided. Each of the radiations in this case heats or does not heat a modification element of the tactile sensation. In this way the radiation from a laser is placed in bijective correspondence with a modification element of the tactile sensation.

In the preferred embodiment of the invention, the control means of the elements of the tactile sensation comprise a laser emitter controlling a plurality of modification elements of the tactile sensation and means for mobilising the radiation with one or two degrees of freedom.

In this case, the tactile sensation will be renewed at a frequency which is a function of the power of the laser, the number of the means of transformation with which a laser is associated, the application time necessary for passing from the rest position to the work position, and the rate of shift made possible by the means for moving the radiation with one or two degrees of freedom.

In the case where the radiation is rendered mobile with a degree of freedom and where the modification elements of the tactile sensation are constituted by a matrix unit in lines and columns, the radiation from a laser common for example to the transformation means of the modification elements of the tactile sensation of a line can be directed successively for example towards each of the modification elements of the tactile sensation of the line to be modified. This control could be effected by first translation means of the laser assigned to this line, or by a reflector controlled in rotation, receiving the radiation from the laser, the rotation of said reflector controlling the rotation of the radiation received to send it to the transformation means of the line which require transformation.

In the case where the radiation is rendered mobile with two degrees of freedom, these two degrees in a first embodiment are constituted by translation means of the laser and a reflector controlled in rotation at the same time. Preferably, in this case the axis of rotation of the reflector is parallel to the translation vector. In this case the translation or rotation means control translation of the translation or the rotation means of the reflector respectively, to send the radiation to a part at least of the modification elements of the display device.

In a second variant of the embodiment comprising one or more lasers with displacement of the radiation according to two degrees of freedom, the second degree of freedom is obtained by the fact that second translation means are added to first translation means, or by the fact that the reflector is rendered mobile in rotation according to two non parallel axes.

In the case of translation it could suffice to shift, for example by means of a double-axis translation plate, one end of a fibre optic whereof the other end receives the radiation from the laser. The same applies in the case of rotation of the reflector, where the incident radiation reaching the reflector could originate from a fibre optic receiving the radiation from the laser.

In the preferred embodiment the shape memory relates only to the linking arm or arms of the blade in continuum of the plate, the arms having a first form above a predetermined temperature and a second form below this temperature. The modification elements of the tactile sensation are thus each constituted by the one blade and its link arm or arms. The blade is a mobile organ linked mechanically to the arm. The radiation output by the laser acts by heating the arm or arms.

Therefore the device according to the present invention enables thermal operation without electrical contact, and this reduces the complexity of the addressing and makes production easier.

Other advantages and characteristics of the invention will emerge from the following description of exemplary embodiments.

### BRIEF DESCRIPTION OF THE DRAWINGS

Embodiments of the invention will now be described in reference to the attached drawings in which the same reference numerals are used for identical elements or having the same function.

FIG. 1 illustrates a plate forming a tactile interface and comprising an array of modification elements of the surface of the plate.

FIG. 2 illustrates a first embodiment of one of the modification elements of the plate in a plan view of a part A and in a sectional view according to the line BB of the part A, in a part B.

FIG. 3 illustrates a plan view of a second embodiment of the invention.

FIG. 4 illustrates a transversal sectional view of a plate according to a variant embodiment of the second embodiment of the invention.

FIG. 5 comprises parts A to F.

Part A illustrates a transversal sectional view of a plate according to a third embodiment of the invention.

Part B illustrates a plan view of a first sub-plate of a third embodiment of one of the modification elements of the plate.

Part C illustrates a view from below of a second sub-plate of the third embodiment of one of the modification elements of the plate,

Part D illustrates a plan view of the third embodiment of one of the modification elements of the plate, the first and second sub-plates being assembled.

Parts E and F illustrate respectively sections according to the lines EE and FF of parts B and C of the shape form of the first and second sub-plates respectively.

FIG. 6 illustrates an exploded view of an embodiment of a device comprising a tactile interface according to the present invention comprising control means by laser in which shift of the laser radiation is obtained by a translation table,

FIG. 7 illustrates an exploded perspective view of another embodiment of a device comprising a tactile interface according to the present invention and comprising control means by laser, in which the shift of the laser radiation is obtained by rotation of the axes of a mirror receiving the radiation put out by the laser emitter,

FIG. 8 illustrates an exploded perspective view of an embodiment of a device comprising a tactile interface according to the present invention, and comprising control means by laser in which the laser emitters are equal in number to the number of tactile modification elements of the plate,

FIG. 9 illustrates a schematic view of an embodiment in which the modification elements of the tactile sensation are made up by a surface of a heat-conducting material.

### DETAILED EXPLANATION OF PARTICULAR EMBODIMENTS

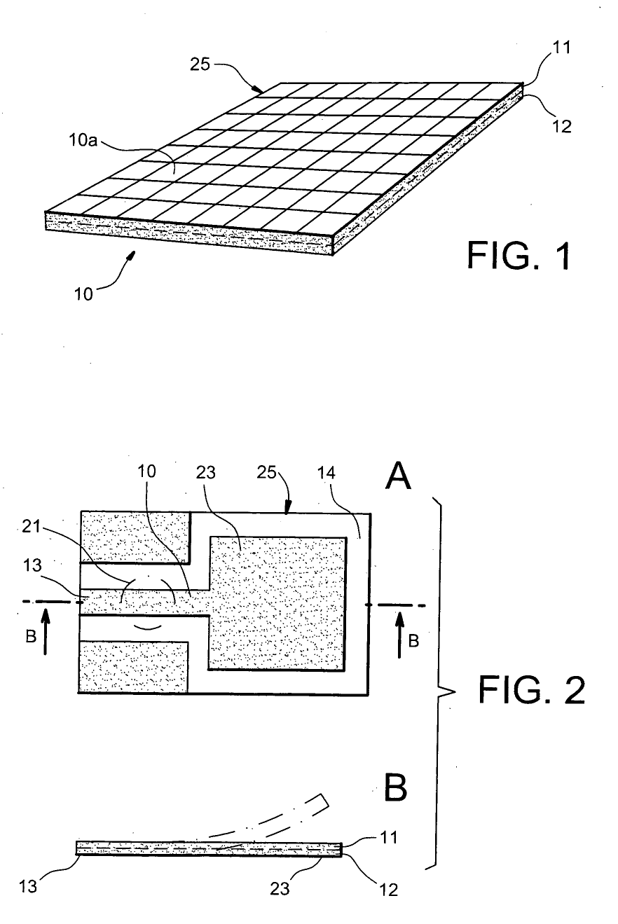

FIG. 1 illustrates a plate 10 having an upper surface 10a comprising an array of modification elements 25 of the surface 10a of the plate 10. Each element 25 has been illustrated in the form of a part, for example a rectangle, of the totality of the surface of the plate 10a. Examples of such elements will be specified hereinbelow. In FIG. 1 these elements 25 have been shown arranged according to a matrix shape in lines and columns. This arrangement is not mandatory. The plate 10 is a plate comprising at least one sub-plate made of a shape memory material. This plate is shown in full lines. It will be seen hereinbelow, in the description of the elements 25, that the plate 10 can comprise for example a layer 12 and a layer 11, each layer forming a sub-plate and the two sub-plates being solid with one another. In FIG. 1 the sub-plates 11, 12 are shown generically, separated by a dotted line. In the two embodiments with one integrated plate or two sub-plates, the plate 10 is in the form of a continuum.

Embodiments of modification elements 25 of the plate 10 will now be described in conjunction with FIGS. 2 to 4.

FIG. 2 comprises a part A and a part B. The part A shows a plan view of a modification element 25 of the surface 10a of the plate 10. The part B shows a transversal section of this same element according to the line BB of the part A. The element 25 is a part in the form of a rectangle of a plate 10 made of a shape memory material having undergone treatment to make it two way. A blade 23 is obtained by a cutout of the plate 10 forming around the blade 23 a recess 14. This recess 14 is present on the entire perimeter of the blade 23, with the exception of a connection part of the blade 23 to an arm 13, connecting the blade 23 to the continuum of the plate 10. The arm 13 has in a first shape memory form a direction parallel to the plane of the plate 10, as shown in full lines in part B. When the temperature of a part of the arm shown schematically at 21 is raised above a predetermined temperature, it takes on a second shape memory form shown in dotted lines in part B. In this second form it forms a non-zero angle with the plane of the plate 10 such that the blade 23 is lifted. When the arm 13 is cooled, it returns to the first memorised form and the blade 23 is again in the plane of the plate 10. In the form shown in FIG. 2, there is a single arm 13. Naturally there could be several arms 13, for example two arms obtained by a longitudinal recess of the arm 13 shown in FIG. 2, this recess going from the blade 23 to the continuum of the plate 10. The same applies to the embodiment described and shown in FIG. 2, where the arm 13 changes form by flexion. The arm 13 can also change its form by torsion. In this case the blade 23 is mobile by rotation about the axis BB. Naturally the arm 13 can also change form by torsion and flexion, giving the blade a shift by two degrees of freedom. In this case and according to the place where the arm 13 is heated, three positions for the blade 23 could be obtained, a first position corresponding to a single flexion, a second position corresponding to a single torsion and finally, a third position corresponding at the same time to torsion, and flexion of the arm 13.

The shape memory material will be for example nickel-titanium or a copper alloy shape memory material, for example, CuZnAl or CuAlNi or CuAIBe.

The form of the element 25 shown in FIG. 2 is applicable also when the invention is made with a plate 10 consisting of two sub-layers or sub-plates 11, 12. In this case the heating of the part 21 causes deformation of the arm 13, causing, as explained earlier, curving and/or torsion of the latter and lifting of the blade 23, as shown in part B. In part B this second alternative has been shown by the fact that the element 25 shown in section is formed by two sub-plates 11, 12 whereof the plane of delimitation is shown by a dotted line.

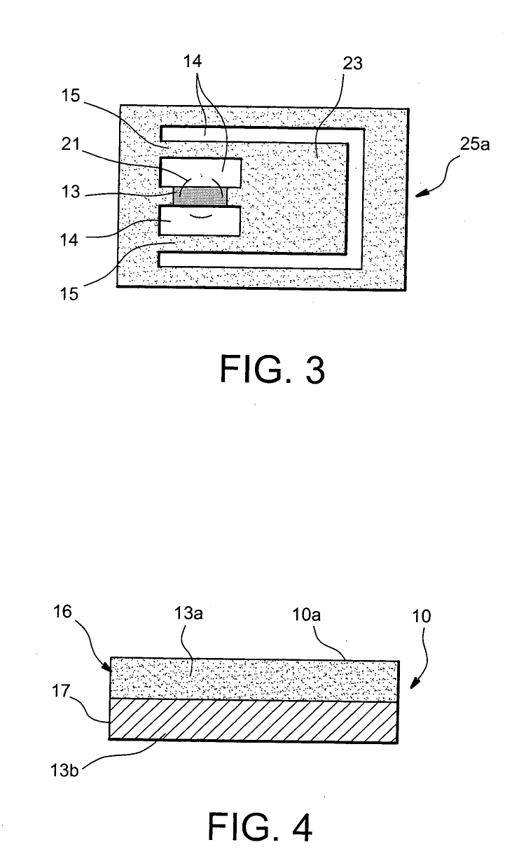

In the embodiment shown in FIG. 3, the shape memory material making up the plate 10 is a one-way material. The blade 23 is connected to the au continuum of the plate by first 13 and second 15 arms. One, as shown in FIG. 3, or more first arms 13 have a first cold form and a second hot form. One or more second arms 15 undergo elastic deformation when the first arms 13 pass from their cold form to their memorised form. Due to this elastic deformation a return force is created which contributes to returning the blade 23 to its first form when it is cooled.

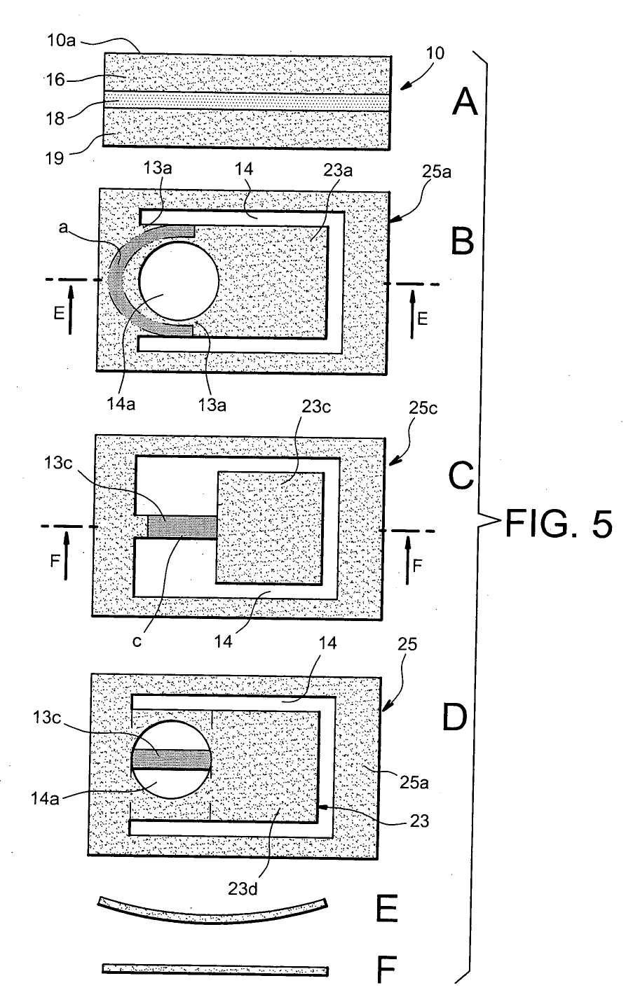

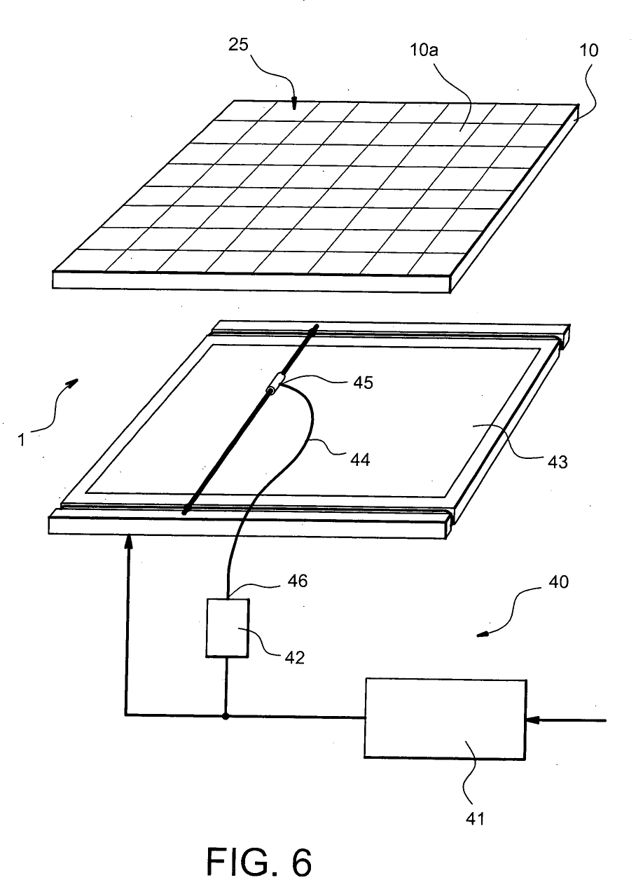

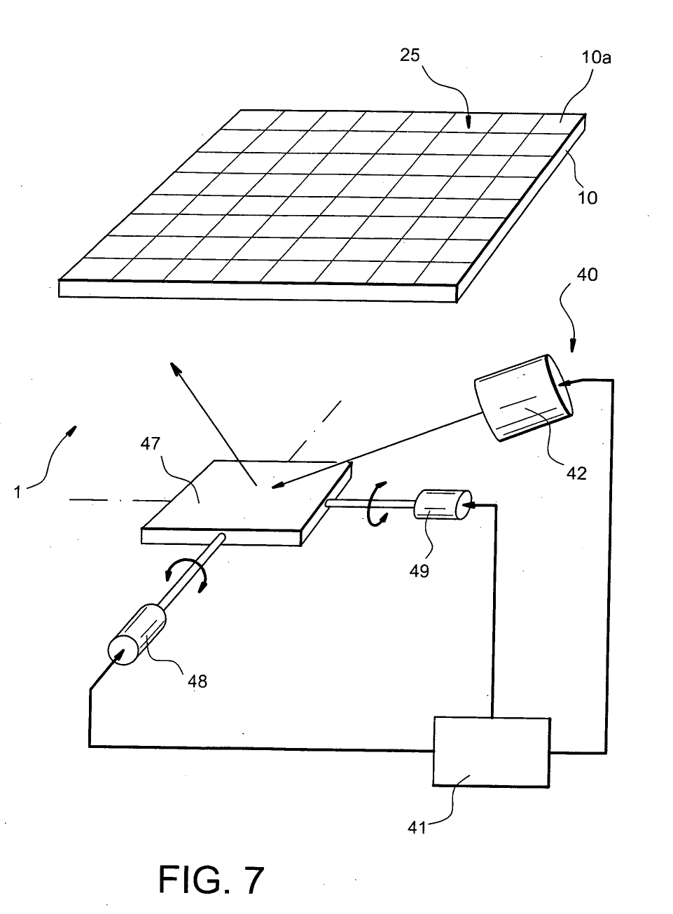

According to a variant of this first embodiment an element 25 of the plate 10 has in a plan view the form above mentioned in relation to FIG. 2. In this variant the plate is formed from two sub-plates 16, 17 assembled on one another for example by welding or bonding, so as to form a single plate, as shown in FIG. 4. A first sub-plate 16 is made of a shape memory material A. A second sub-plate 17 is made of an elastic material B. The material B can be for example spring steel or a copper-beryllium alloy or a harder material such as silicon used in microelectronics. In this configuration the arm 13 and the blade 23 having the form shown in FIG. 2 in a plan view are, similar to the rest of the plate, formed from two sub-plates 16, 17 superposed on one another. The arm 13 comprises two superposed parts 13a and 13b respectively. When a part for example 21 of the upper part 13a of the arm 13 of the first sub-plate made of material A is heated, it will cause deformation of this part by deformation of the material A, causing elastic deformation of the part 13b of the arm 13 made of material B. When, due to the natural or active cooling of the material A, the material A is less rigid, the return of the material B to its initial form by elastic effect causes the materials A and B to return to the first form.

Therefore, in this embodiment and in its variant, modification elements 25 of the surface 10a of the plate 10 comprising the shape memory material, incorporating elastic elements 15, 13b mechanically connected on the one hand to the plate 10 and on the other hand to the modification element 25 to which they belong, these elastic elements exerting a return force on the modification element 25 of the surface of the plate 10 to take it from the second to the first form.

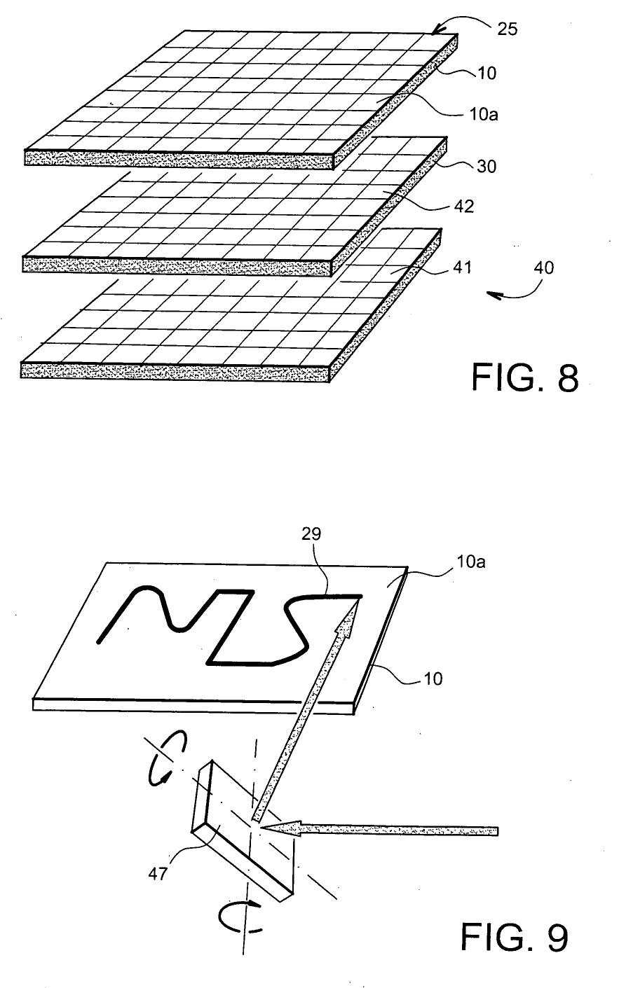

According to a third embodiment shown in FIG. 5 part A, the plate 10 is formed by two sub-plates 16, 19 assembled on one another for example by welding or bonding so as to form only a single plate 10. In the preferred form of this embodiment, the two sub-plates 16, 19 are adherent one to the upper face and the other to the lower face of an intermediate layer 18 made of a thermally insulating material. A first sub-plate 16 is made of a shape memory material A. A sub-plate 19 is made of a second shape memory material C having a memorised form different from the memorised form of the first. An exemplary embodiment of a modification element 25 is shown in a plan view in FIG. 5, part B. In this view, only a part 25a of the element 25 made in the upper sub-plate 16 is apparent. A blade 23a is obtained in the sub-plate 16 by means of two recesses 14, a first 14 having a U shape surrounding the blade 23a on three of its sides, and a second 14a having a form of a circle located substantially to the side of the open part of the U. The recess 14a in the form of a circle has a diameter less than the distance separating the two parallel arms of the U such that two arms 13a join the blade 23a to the rest of the continuum of the plate.

FIG. 5 part C shows a view from below of the element 25. In this view, only a part 25c of the element 25 made in the sub-plate 19 is apparent. A blade 23c is obtained by a recess 14 right around the blade, with the exception of a central arm 13c joining the blade 23c to the rest of the continuum of the plate. In FIG. 5 parts B and C two shaded parts a and c respectively are shown to which heating is applied for changing form.

The heating can be applied by any known means. It can also be applied by irradiation by a laser beam scanning the zone to be heated.

The assembly of the parts 25a and 25c is shown in a plan view in FIG. 5 part D. In this figure the sub-part 25a of a modification element 25 of the surface 10a of the plate 10 formed in the sub-plate 16 has its recessed part 14a present above the full sub-part 13c forming in the present case the arm 13c of the sub-part 25c of the other sub-plate 19. This arrangement is advantageous in the sense that a single scanning laser can be used to heat either the deformable part shown in FIG. 5 part B of the upper sub-part 16 or alternatively the deformable part 13c of the lower plate 19.

This operates as follows:

The part a of the sub-plate 16 made of material A for example is deformed by heating and regains its memorised form. This form is shown in a transversal section in FIG. 5 part E. Due to this deformation the blade 23 is lifted and is no longer flush with the plane of the plate 10. The deformation of the part a made of material A causes mechanical deformation of the corresponding part of the sub-plate 19 made of material C. If at this stage the alloy C is heated, at the level of the arm 13c, the alloy C regains its memorised form. This memorised form is shown in FIG. 5 part F. In this case this is a flat form which brings back to the plane of the plate 10 the blade 23 such that the ensemble of the two alloys A and C regain their initial form.

FIG. 6 shows a an exploded perspective view of a first embodiment of a device comprising a tactile interface in the form of a plate 10 according to the present invention, in which control means 40 comprise laser means 42.

The display device 1 comprises a touch plate 10, as described hereinabove in relation to FIG. 1. The touch plate can also in this case be a plate made of heat-conductive material, in the form of a continuum. In this instance, even though the modification elements of the tactile sensation cannot be distinguished physically, elements do exist all the same. They are determined at each instant, for example in the form of pixels, by the position of the radiation laser on the surface. The size of the pixels here is determined by the size of the minimum surface which is heated by a radiation laser applied to a surface of the plate situated for example opposite the touch surface 10a, without any visual distinction of a delimitation of these elements being possible. The modification of the tactile sensation thus consists of a difference in temperature between hot pixels and cold pixels.

The device 1 also comprises control means 40 for selectively addressing the transformation means 21 of the modification elements 25 of the tactile sensation, so a to produce at any instant a tactile sensation determined at the level of the whole of the surface 10a of the touch plate 10.

In keeping with this embodiment of the invention, the control means 40 of the modification elements 25 of the tactile sensation comprise one or more laser emitters 42 whereof the radiation from each is utilised to make the transformation from one or more modification elements 25 of the tactile sensation. In FIG. 6 a single laser 42 has been shown. In the example shown the radiation from the laser 42 can be moved to each of the modification elements 25 of the tactile sensation. For this the laser emitter 42 is mounted on a translation table 43 which can be a table fitted with a translation axis and first translation means according to this first axis, or a table of two axes equipped with second translation means according to this second axis, known per se, in one or the other of these forms. In a manner also known per se the table 43 is equipped with motor means not shown for shifting the laser emitter and thus the point of application of its radiation successively under transformation means 21 selected by a control circuit 41, receiving the tactile data to be displayed. The circuit 41 on the one hand controls the motor means of the translation table 43 and on the other hand the emission or not from the laser emitter 42, for example by action on a Pockel cell in optic series with the laser emitter 42 and a polariser. All these elements well known in themselves have not been illustrated here. Similarly, radiation focalisation means for example in the form of a lens have not been illustrated.

It is not obligatory that the laser emitter 42 is shifted. It could be enough, as shown in FIG. 6, to shift an end 45 of a fibre optic 44, whereof the other end 46 receives radiation from the laser emitter 42.

Thus in the example shown in FIG. 6, the control means 40 of the modification elements 25 of the tactile sensation comprise, apart from the laser emitter 42, the control circuit 41, the table 43 and optionally a fibre optic 44. This works as follows.

For each tactile image to be formed, the radiation laser is shifted successively by means of the table 43, towards the modification elements 25 of the tactile sensation, which must be transformed into a working position, to form the image. Transformation can be achieved in a single pass, with a stop time on each modification element of the tactile sensation sufficing to cause transformation of the element. Transformation can also be achieved in a number of successive passes, with the total of the successive stop times on each modification element 25 of the tactile sensation being sufficient to cause transformation of the element. A next image following a former image is applied in the same way after the time necessary for the return of the modification elements 25 of the tactile sensation to a rest position.

FIG. 7 shows an exploded perspective view of a second embodiment of a device comprising a tactile interface in the form of a plate 10 according to the present invention, in which control means 40 comprise laser means 42. In reference to FIG. 6, the translation table 43 has been replaced by mobile mirror 47 mobile according to two perpendicular axes. The laser emitter 42 emits its radiation directly by means of a fibre optic, not shown here, to the mobile mirror 47. The control circuit 41 receiving the tactile data to be displayed, controls by way of position changing means 48, 49 the position in rotation of the mirror 47. Such rotation means of a reflector are known per se.

The operation is the same as in the example shown in FIG. 6, with the radiation shift being in this case produced by rotation controlled by the mirror 47.

FIG. 8 shows an exploded perspective view of a third embodiment of a device comprising a tactile interface in the form of a plate 10 according to the present invention, in which control means 40 comprise laser means 42. In this third mode the laser emitters 42 are equal in number to the number of tactile modification elements 25 of the touch plate 10.

In this third embodiment the control means 40 comprise a monolithic layer 30, preferably obtained by utilisation of collective fabrication techniques, especially micro-electronics. This layer comprises a number of lasers 42 equal to the number of modification elements 25 of the tactile sensation. The radiation from a laser emitter 42 can be applied univalently to a single element 25. The control circuit 41 is in this case a simple address circuit for emitters 42 which must emit for the formation of a current image. Although this embodiment requires an address circuit which can become complex if the number of elements 25 to be addressed is large, it has the advantage of being able to be made according to collective manufacturing techniques, as mentioned earlier for the layer 30, but also for the touch plate 10, and the address circuit 4.

1. A device comprising a tactile interface formed by a plate (10) having a surface (10a) capable of being modified in a controlled manner, the plate comprising an array of elements (25) for modification of the surface (10a), the device also comprising control means of the modification elements of the surface (e10a), characterised in that the plate (10) is made of a shape memory material A or comprises at least one sub-plate made of shape memory material A, and in that the array of modification elements (25) of the surface (10a) of the plate (10) is constituted by an array of one or more blades (23) solid monolithically with the plate (10) by one or more arms (13) solid monolithically with the plate (10), one or more recesses (14) for releasing blades being present on a part of a perimeter of the blade (23), the blade (23) having a first position at a first temperature and a second position at a second temperature.

2. The device comprising a tactile interface formed by a plate (10) made of a shape memory material as claimed in claim 1, characterised in that the shape memory material making up the plate (10) is a two-way material having a first hot form and a second cold form.

3. A device comprising a tactile interface formed by a plate (10) made of a shape memory material as claimed in claim 1, characterised in that modification elements (25) of the surface (10a) of the plate (10) incorporate elastic elements (15, 13b) mechanically connected on the one hand to the plate (10) and on the other hand to the modification element (25) of the surface of the plate to which these elastic elements (15, 13b) belong, exerting a return force on the modification element (25) of the surface of the plate (10) to bring it back from the second to the first form.

4. A device comprising a tactile interface formed by a plate (10) made of a shape memory material as claimed in claim 2, characterised in that modification elements (25) of the surface (10a) of the plate (10) incorporate elastic elements (15, 13b) mechanically connected on the one hand to the plate (10) and on the other hand to the modification element (25) of the surface of the plate to which these elastic elements (15, 13b) belong, exerting a return force on the. modification element (25) of the surface of the plate (10) to bring it back from the second to the first form.

5. The device comprising a tactile interface formed by a plate (10) made of a shape memory material as claimed in claim 1, characterised in that it is formed from two sub-plates (15,17; 16, 19) solid with one another by a main common surface.

6. The device comprising a tactile interface formed by a plate (10) made of a shape memory material as claimed in claim 5, characterised in that one of the sub-plates (16) is made of a shape memory material.

7. The device comprising a tactile interface formed by a plate (10) made of a shape memory material as claimed in claim 5, characterised in that the two sub-plates (16, 19) are made of a shape memory material.

8. The device comprising a tactile interface formed by a plate (10) made of a shape memory material as claimed in claim 7, characterised in that a sub-part (25a) of a modification element (25) of the surface (10a) of the plate (10) formed in one of the sub-plates (16) has a recessed part (14a) present above a part (13c) of a full sub-part (25c) of the other sub-plate (19).

9. The device comprising a tactile interface formed by a plate (10) made of a shape memory material as claimed in claim 6, characterised in that a layer (18) made of thermally insulating material is interposed between the two sub-plates (16, 39) made of shape memory material.

10. The device (1) comprising a tactile interface as claimed in claim 1, characterised in that the control means (40) of the transformation of the modification elements (25) of the tactile sensation comprise one or more laser emitters (42) whereof the radiation from each is utilised to create the transformation of one or more modification elements (25) of the tactile sensation, the radiation emitted by a laser emitter (42) acting by heating arms (13), the deformation of arms (13) causing a blade to pass from the first to the second position.

11. The device (1) comprising a tactile interface as claimed in claim 10, characterised in that the control means (40) of the modification elements (25) of the tactile sensation comprise as many laser emitters (42) as modification elements (25) of the tactile sensation, with the radiation from a laser (42) being put in bijective correspondence with a modification element (25) of the tactile sensation.

12. The device (1) comprising a tactile interface as claimed in claim 10, characterised in that the control means (40) of the modification elements of the tactile sensation comprise a laser emitter (42) controlling a plurality of modification elements (25) of the tactile sensation and means (43, 44, 47) for mobilising the radiation with one or two degrees of freedom.

13. The device (1) comprising a tactile interface as claimed in claim 10, characterised in that it comprises a fibre optic (44) having an inlet end (46) receiving the radiation output by the laser emitter (42) and an outlet end (45) for the laser radiation, with the radiation used to produce transformation of one or more modification elements (25) of the tactile sensation originating from said outlet of the fibre optic.

14. The device (1) comprising a tactile interface as claimed in claim 12, characterised in that it comprises a translation plate (43), the laser emitter being shifted by this plate (43).

15. The device (1) comprising a tactile interface as claimed in claim 12, characterised in that it comprises a translation plate (43), the outlet end (45) of the fibre optic (44) being shifted by this plate (43).

16. The device (1) comprising a tactile interface as claimed in claim 12, characterised in that it comprises a reflector (47) controlled in rotation, this reflector receiving the radiation originating from a laser emitter (42).

17. The device (1) comprising a tactile interface as claimed in claim 13, characterised in that it comprises a reflector (47) controlled in rotation, this reflector receiving the radiation originating from a laser emitter (42) via the fibre optic (44).
